(19) United States
(12) Patent Application Publication
(10) Pub. No.: US 2017/0115849 A1
(43) Pub. Date: Apr. 27, 2017

(54) ICON MOVING METHOD AND DEVICE

(71) Applicants: LE HOLDINGS (BEIJING) CO., LTD., Beijing (CN); Lemobile Information Technology (Beijing) Co., Ltd, Beijing (CN)

(72) Inventor: Tao YANG, Beijing (CN)

(21) Appl. No.: 15/246,319

(22) Filed: Aug. 24, 2016

Related U.S. Application Data
(63) Continuation of application No. PCT/CN2016/088405, filed on Jul. 4, 2016.

(30) Foreign Application Priority Data
Oct. 26, 2015 (CN) 201510705727.4

(51) Int. Cl. G06F 3/0481; G06F 3/0488; G06F 3/0486

(52) U.S. Cl. CPC G06F 3/04817; G06F 3/0486; G06F 3/04886; G06F 2203/04803

(57) ABSTRACT

The embodiments of the present disclosure disclose a. method and device for moving icons for solving the problem in the prior art where the movement is inaccurate, the operating process is complicated and the moving efficiency is low when icon is moved across the screens. The method comprises the steps of receiving a dragging command to an icon, and displaying the thumbnail previews of all split screens in the desktop in the set region when the icon is detected to be dragged within the set region of the desktop; receiving a dragging stopping command to the icon, and moving the icon to the split screen corresponding to the target thumbnail preview if the icon is currently dragged to some target thumbnail preview. According to the embodiments of the present disclosure, the cross-screen movement is more accurate, the operating process is simpler and more convenient, and the moving efficiency is high.

### CROSS-REFERENCE TO RELATED APPLICATIONS

The present disclosure is a continuation of International Application No. PCT/CN2016/088405 filed on Jul. 4, 2016, which claims priority to Chinese Patent Application No. 201510705727.4 entitled “ICON MOVING METHOD AND DEVICE”, filed on Oct. 26, 2015, the entire contents of all of which are incorporated herein by reference.

### FIELD OF TECHNOLOGY

The embodiments of the present disclosure relate to the technical field of mobile terminals, and particularly relate to an icon moving method and device.

### BACKGROUND

With the rapid development of mobile terminals, types of the mobile terminals are increasingly abundant and the functions are more and more powerful. Mobile terminals have already become indispensable communication. tools in people's life and work. The requirements on the usage experience of the mobile terminals by the users are higher and higher. At present, the majority of users increasingly welcome intelligent mobile terminals. The intelligent mobile terminals have independent operating systems, and are powerful in function and high in practicality. The users can install kinds of application software by themselves to expand the functions. In order to use these applications conveniently by the user, icons with installed applications are exhibited in the desktop of the mobile terminal and the user can enter corresponding applications through the icons. Moreover, the desktop further can provide a function of moving the icons, so that the user can more conveniently organize and use the applications, and therefore, the user's desktop is more personalized. With increase of the installed applications, the icons of the applications are often exhibited in the desktop in a split screen mode, so that when the icons are moved, cross-screen movement will be a frequently used operation.

In the prior art, when cross-screen movement is performed on the icon, the icon needed to be moved is often dragged to the edge of some split screen and is continuously moved to the edge, and at the moment, the desktop correspondingly slides to the split screen corresponding to the direction of the edge to switch the split screens, so that cross-screen movement on the icon is realized.

However, the different between the operation of dragging the icon and the operation of dragging the icon when the icon is moved to the edge of some split screen is relatively small, so that accidental operation is easily caused, and movement is inaccurate; moreover, when the icon is moved across a plurality of split screens, the operating process is complicated and the moving efficiency is low.

### SUMMARY

The embodiments of the present disclosure disclose an icon moving method and device for solving the problem that in the prior art, the movement is inaccurate, the operating process is complicated and the moving efficiency is low when icon is moved across the screens.

According to one aspect of the present disclosure, the embodiments of the present disclosure pro Tide an icon moving method, including:

receiving a dragging command to an icon and displaying a thumbnail preview of a part of split screens in the desktop in a set region when the icon is detected to be dragged to the set region in the desktop; and

receiving a dragging stopping command to the icon, and moving the icon to the split screen corresponding to the target thumbnail preview when the icon is currently dragged to some target thumbnail preview.

According to another aspect of the present disclosure, the embodiments of the present disclosure provide a mobile terminal for icon moving, including at least one processor; and a memory communicably connected with the at least one processor for storing instructions executable by the at least one processor, wherein execution of the instructions by the at least one processor causes the at least one processor to:

receive a dragging command to an icon and display a thumbnail preview of a part of split screens in the desktop in a set region when the icon is detected to be dragged to the set region in the desktop;

receive a dragging stopping command to the icon, and move the icon to the split screen corresponding to the target thumbnail preview when the icon is currently dragged to some target thumbnail preview.

According to another aspect of the present disclosure, the present disclosure provides a computer program, which includes a computer readable code. When the computer readable code operates in a mobile terminal, the mobile terminal executes the icon moving method.

According to another aspect of the present disclosure, the present disclosure provides a computer readable medium, wherein the computer program is stored therein.

The present disclosure has the beneficial effects that:

according to the icon moving method and device provided by the embodiments of the present disclosure, after the dragging command to the icon is received; the position, in which the icon is dragged is detected; thumbnail previews of all split screens in the desktop are displayed in the set region when the icon is detected to be dragged to the set region in the desktop; the icon can be drag to any one of the thumbnail previews subsequently; the dragging stopping command to the icon is received, and if the icon is currently dragged to some target thumbnail preview, the icon is moved to the split screen corresponding to the target thumbnail preview. It can be seen that according to the embodiments of the present disclosure, when the icon is moved across the screens, the icon can be directly moved to any split screen corresponding to the thumbnail preview based on the thumbnail previews of all displayed split screens without the need of switching the split screens by adopting a method in the prior art, so that the cross-screen movement is more accurate, the operating process is simpler and more convenient and the moving efficiency is high according to the embodiments of the present disclosure.

The above description is only the summary of the technical scheme of the present disclosure. In order to understand the technical means of the present disclosure more clearly to implement the technical means according to the content of the description, and to make the above and other purposes, characteristics and advantages of the present disclosure more obvious and understandable, detailed description of the present disclosure are listed below.

### BRIEF DESCRIPTION OF THE DRAWINGS

In order to illustrate the technical scheme in the embodiments of the present disclosure or in the prior art more clearly, the drawings needed to be used in the embodiments of the present disclosure are simply introduced. It is obvious that the drawings in the description are some embodiments of the present disclosure. As far as ordinary technical staff in the field is concerned, on the premise of not contributing creative labor, other drawings can be further obtained according to the drawings.

FIG. 1 is a step flow diagram of an icon moving method according to a first embodiment of the present disclosure.

FIG. 2 is a step flow diagram of an icon moving method according to a second embodiment of the present disclosure.

FIG. 3 is a schematic diagram of displaying prompt information in the set region according to the second embodiment of the present disclosure.

FIG. 4 is a schematic diagram of displaying the thumbnail previews in the set region according to the second embodiment of the present disclosure.

FIG. 5 is a structural block diagram of an icon moving method according to a third embodiment of the present disclosure.

FIG. 6 is a structural block diagram of an icon moving device according to a fourth embodiment of the present disclosure.

FIG. 7 schematically depicts a block diagram of a mobile terminal for executing the method according to the present disclosure.

FIG. 8 schematically depicts a storage unit for keeping or carrying a program code which realizes the method according to the present disclosure.

### DESCRIPTION OF THE EMBODIMENTS

In order to make the purpose, technical scheme and advantages of the embodiments of the present disclosure more clear, the technical scheme according to the embodiments of the present disclosure are clearly and integrally described by combining the drawings in the embodiments of the present disclosure. Obviously, the described embodiments are part of embodiments of the present disclosure rather than all the embodiments. On the basis of the embodiments of the present disclosure, all the other embodiments obtained by the ordinary technical staff in the field on the premise of not contributing creative labor shall fall into the scope of the present disclosure.

### First Embodiment

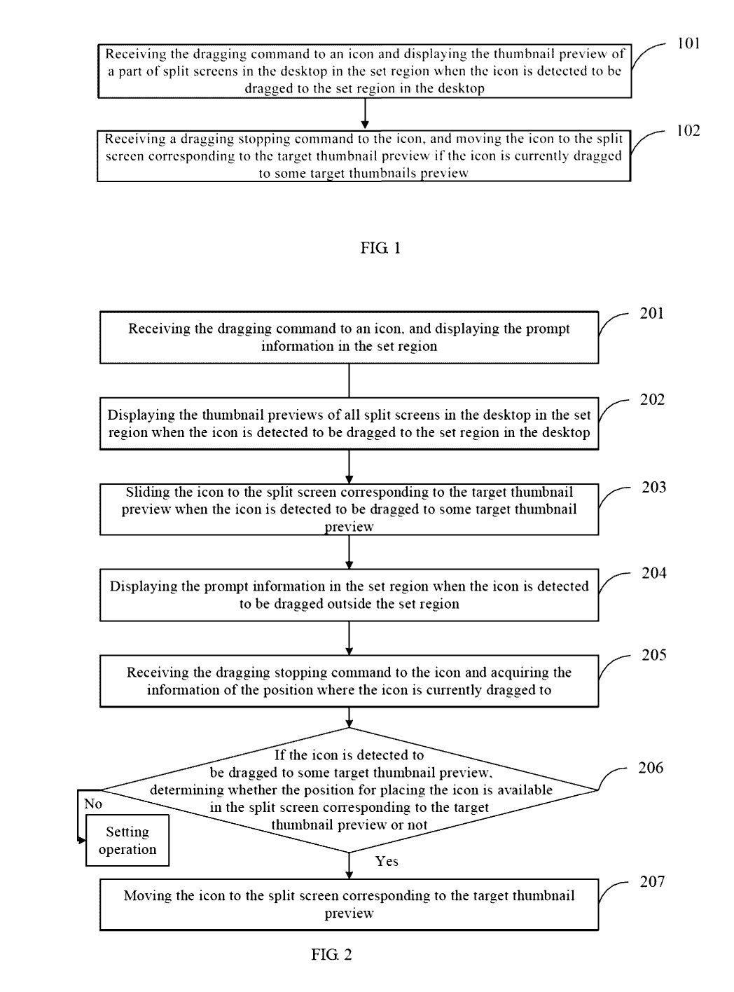

With the FIG. 1, the step flow diagram of the icon moving method according to the first embodiment of the present disclosure is depicted.

The icon moving method according to the embodiment of the present disclosure can include the steps as follows.

Step 101, receiving a dragging command to an icon and displaying a thumbnail preview of a part of split screens in the desktop in a set region when the icon is detected to be dragged to the set region in the desktop.

In the embodiment of the present disclosure, the mobile terminal can be a mobile phone, a tablet personal computer, a notebook computer and the like. A plurality of icons can he displayed in the desktop of the mobile terminal. The icons can include all objects in the desktop, for example, application icons, document icons, folder icons and the like. If not all the icons can be displayed in one screen, the icons are displayed in the desktop in a split screen mode, and each screen can display a set number of icons. The icon can move in the split screen where the icon is, and further can move cross the screens among the split screens.

When some icon needs to be moved, the user can press and hold the icon to trigger a dragging command to the icon, and at that moment, the user can begin to drag the icon. In the embodiment of the present disclosure, a set region can be set in the desktop of the mobile terminal in advance. The set region can be used for displaying relevant contents when the icon is moved across the screens, for example, the thumbnail previews of the split screens etc. The set region can be set in any appropriate position in the desktop, for example, the top, the bottom, the side etc. of the desktop. The embodiment of the present disclosure does not limit the specific position of the set region. After receiving the dragging command to the icon, the mobile terminal will detect the information of the position where the icon is dragged to in real time. When the icon is detected to be dragged to within the set region in the desktop, the mobile terminal will display the thumbnail previews of all split screens in the desktop in the set region. The user can intuitively understand relevant information of the corresponding split screens through the thumbnail previews, so that the user can more conveniently move the icon across the screens among the split screens.

Step 102, receiving a dragging stopping command to the icon, and moving the icon to the split screen corresponding to the target thumbnail preview if the icon is currently dragged to some target thumbnail preview.

When the icon is dragged to an expected position, the user can stop pressing and holding the icon, loosening their finger and, at that moment, the dragging stopping command to the icon can be triggered. After receiving the dragging stopping command, if the mobile terminal determines that the icon is currently dragged to some target thumbnail preview of all the thumbnail previews displayed in the set region, the icon is moved to the split screen corresponding to the target thumbnail preview, so that the icon can be directly moved to any one split screen across the screen. Even if the icon needs to cross the plurality of screens, the movement can be further realized by a once-through operation.

According to the icon moving method provided by the embodiment of the present disclosure, after the dragging command to the icon is received; the position where the icon is dragged is detected; thumbnail previews of all split screens in the desktop are displayed in the set region when the icon is detected to be dragged to the set region in the desktop; the icon can be drag to any one thumbnail preview subsequently; the dragging stopping command to the icon is received, and if the icon is currently dragged to some target thumbnail preview, the icon is moved to the split screen corresponding to the target thumbnail preview. It can be seen that according to the embodiment of the present disclosure, when the icon is moved across the screens, the icon can be directly moved to any split screen corresponding to the thumbnail preview based on the thumbnail previews of all displayed split screens without the need of switching the split screens by adopting a method in the prior art, so that the cross-screen movement is more accurate, the operating process is simpler and more convenient and the moving efficiency is high according to the embodiments of the present disclosure.

### Second Embodiment

With the FIG. 2, the step flow diagram of the icon moving method according to the second embodiment of the present disclosure is depicted.

The icon moving method according to the embodiment of the present disclosure cm include the steps as follows.

Step 201, receiving the dragging command to an icon, and displaying the prompt information in the set region.

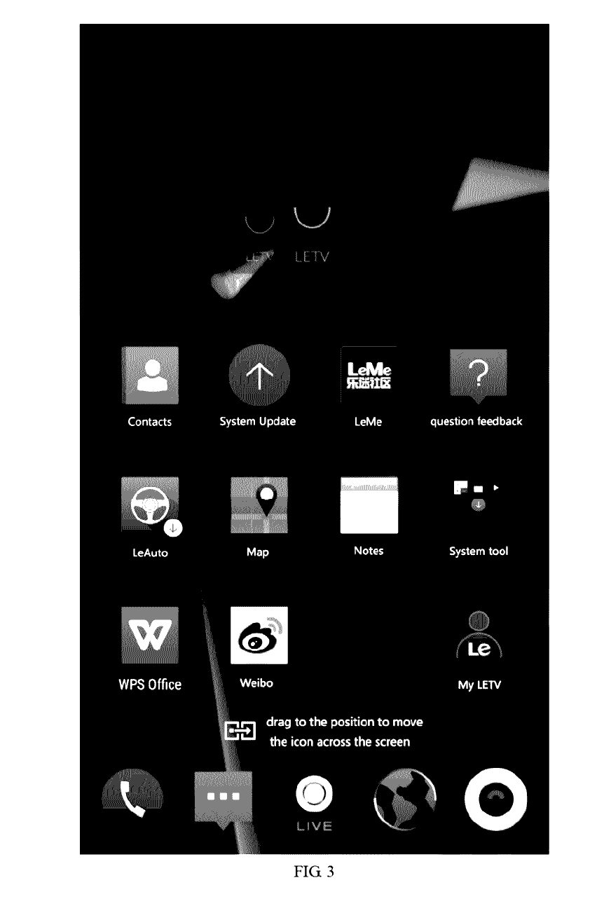

In the embodiment of the present disclosure, the prompt information can be further set in advance. After receiving the dragging command to the icon, the mobile terminal firstly displays the prompt information in the set region which is preset, and the prompt information is used for prompting that the set region is a cross screen operating region so as to prompt that the user can more conveniently perform the operation of moving the icon across the screens in the set region,

wherein the prompt information can be any applicable information such as characters and pictures. The embodiment of the present disclosure does not limit the prompt information. With reference to FIG. 3, a schematic diagram of displaying the prompt information in the set region according to the second embodiment of the present disclosure is depicted. In the FIG. 3, the user drags the icon labeled as “LETV” in the current split screen and at that moment, the prompt information will he displayed in the set region. The characters “drag to the position to move the icon across the screen” shown in the FIG. 3 and a small picture “ [symbol] ” on the left side of the characters are prompt information.

Step 202, displaying the thumbnail previews of all split screens in the desktop in the set region when the icon is detected to be dragged to the set region in the desktop.

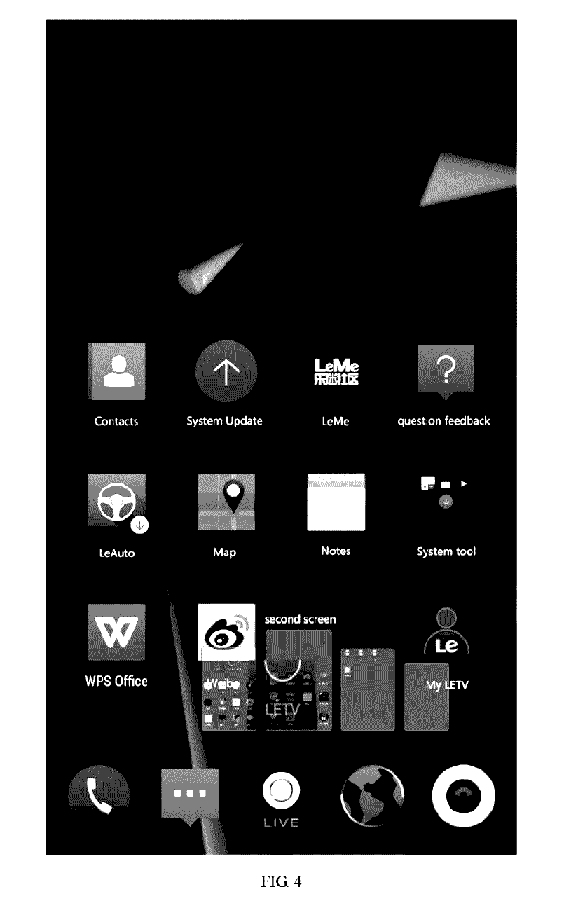

In the process of dragging the icon by the user, corresponding dragging information will be generated, for example, information of the dragged icon (such as identifier), the information of the position dragged to and the like. After receiving the dragging command to the icon, the mobile terminal will detect the information of the position where the icon is dragged to in real time and display the thumbnail previews of all split screens in the desktop in the set region when the icon is detected to he dragged to within the set region in the desktop, and at the moment, the prompt information displayed in the step 201 will be hidden. With reference to FIG. 4, a schematic diagram of displaying the thumbnail preview in the set region according to the second embodiment of the present disclosure is depicted. It can be known from the FIG. 4, four thumbnail previews are displayed in the set region, so that the desktop includes four split screens, and the desktop currently displays the second screen.

It should he noted that in order to smoothly display the thumbnail previews of all split screens, a process of acquiring the thumbnail previews of all split screens in the desktop is further needed to be executed before display. The process of acquiring the thumbnail previews of all split screens in the desktop can adopt the following modes: a first mode: drawing the thumbnail previews of all split screens, for example, reducing the split screens in scale and drawing the split screens to the thumbnail previews; the drawing mode can be executed after receiving the dragging command to the icon in the step 201 and further can be executed when the icon is detected to be dragged to the set region in the desktop in the step 202; a second mode: storing the thumbnail previews of all split screens to cache of the mobile terminal in advance, and directly acquiring the thumbnail previews of all split screens from the cache during acquiring. The acquiring mode can be executed when the icon is detected to be dragged to the set region in the desktop in the step 202.

Step 203, sliding the icon to the split screen corresponding to the target thumbnail preview when the icon is detected to be dragged to some target thumbnail preview.

Preferably, in the embodiment of the present disclosure, the information of the position where the icon is dragged to is continuously detected after the thumbnail previews of all split screens in the desktop are displayed in the set region, and when the icon is detected to be dragged to some target thumbnail preview, the desktop can be further slid to the split screen corresponding to the some target thumbnail preview, so that the user can more clearly examine the content in the split screen.

Step 204, displaying the prompt information in the set region when the icon is detected to be dragged outside the set region.

Preferably, in the embodiment of the present disclosure, after the thumbnail previews of all split screens in the desktop are displayed in the set region, if the icon is detected to be dragged outside the set region, in order to reduce the space occupied by the thumb mil previews when cross-screen movement is not needed, the thumbnail previews of all split screens will be hidden, and the described prompt information in the step 201 will be displayed in the set region.

It should be noted that the arrangement sequence of the step 203 and the step 204 does not represent the executing sequences of the two. There is no special successive executing sequence between the two. Corresponding processes can be executed as long as the executing conditions of the two are satisfied.

Step 205, receiving the dragging stopping command to the icon and acquiring the information of the position where the icon is currently dragged to.

When the icon is dragged to the expected position, the dragging stopping command to the icon can be triggered. For example, in the step 202, in the process of dragging the icon by the user, corresponding dragging information will be generated, for example, information of the dragged icon, the information of the position where the icon is dragged to and etc. Therefore, the mobile terminal receiving the dragging stopping command can acquire the information of the position where the icon is currently dragged to further determine the subsequently executed operation.

Step 206, if the icon is detected to be dragged to some target thumbnail preview, determining whether the position for placing the icon is available in the split screen corresponding to the target thumbnail preview. If so, the step 207 is executed; otherwise, the setting operation is executed.

If the position information prompt icon acquired in the step 205 is currently dragged to some target thumbnail preview, whether the position for placing the icon is available or not in the split screen corresponding to the target thumbnail preview is further determined, for example, a blank position for placing the icon is available or not in the split screen corresponding to the target thumbnail preview is determined, if so, the sep 207 is executed to move the icon to the split screen corresponding to the target thumbnail preview; otherwise, the setting operation is executed.

Preferably, the setting operation according to the embodiment of the present disclosure can be moving the icon to the position before the icon is dragged; the setting operation further can be moving the icon to the position of the set icon in the split screen corresponding to the target thumbnail preview and moving the set icon to an adjacent split screen of the split screen corresponding to the target thumbnail preview, for example, the icon at the lower right corner of the split screen corresponding to the target thumbnail preview can be used as the set icon, and the set icon is moved to the next split screen of the split screen corresponding to the target thumbnail preview. For another example, the icon at the upper left corner of the split screen corresponding to the target thumbnail preview can be used as the set icon, and the set icon is moved to the previous split screen of the split screen corresponding to the target thumbnail preview etc. The embodiment of the present disclosure does not limit the setting operation. Off course, the setting operation further can be other operations. The technical staff in the field can select any applicable operations according to actual experience.

Step 207, moving the icon to the split screen corresponding to the target thumbnail preview.

If many positions for placing the icon available in the split screen corresponding to the target thumbnail preview are determined in the step 206, the icon can be directly moved to the split screen corresponding to the target thumbnail preview. Specifically, the icon can be automatically moved to corresponding blank positions of the split screen corresponding to the target thumbnail preview, for example, the icon is moved to the blank position at the lower right corner of the split screen corresponding to the target thumbnail preview etc. The embodiment of the present disclosure does not limit the special moved position.

It should be noted that the step 206 and the step 207 depict that the icon is currently dragged to some target thumbnail preview when the dragging stopping command to the icon is received. There is another condition in the embodiment of the present disclosure, that is, the icon is currently dragged to some position of the currently displayed split screen in the desktop when the dragging stopping command to the icon is received. Under this circumstance, whether the icon is placed in the position or not can be further judged. If the icon is placed in the position, the dragged icon can be moved to the position and the icon and the icons behind the icon are moved backward a position; if the icon is not placed in the position, that is, the position is the blank position, the dragged icon can be directly moved to the blank position. With respect to the specific process of the circumstance, the technical staff in the field performs relevant processing according to actual experience. No detailed description is listed in the embodiment of the present disclosure.

In the embodiment of the present disclosure, the thumbnail previews of all split screens can he displayed in the set region, so that the icon can be directly moved to the split screen corresponding to any one thumbnail preview, and therefore, the user can move conveniently perform the operation of moving the icon across the screens, accidental operation during cross-screen movement can be reduced, and the efficiency of cross-screen movement can be improved.

With respect to the embodiments of the method, in order for simple description, the embodiments are expressed as a series of movement combination. However, the technical staff in the field shall know that the present disclosure is not limited by the described movement sequence as some steps can be in other sequences or can be simultaneously performed according to the present disclosure. Then, the technical staff in the field shall also know that the embodiments described in the description are preferred embodiments, and referred movements and modules are not necessary to the embodiments of the present disclosure.

### Third Embodiment

With reference to FIG. 5, a structural block diagram of an icon moving method according to a third embodiment of the present disclosure is depicted.

The icon moving device according to the embodiment of the present disclosure can include the following modules:

a thumbnail displaying module 501 for receiving a. dragging command to an icon and displaying thumbnail previews of all split screens in the desktop in a set region when the icon is detected to be dragged to the set region in the desktop; and

an icon moving module 502 for receiving the dragging stopping command to the icon, and moving the icon to the split screen corresponding to the target thumbnail preview if the icon is currently dragged to some target thumbnail preview.

According to the icon moving device provided by the embodiment of the present disclosure, after the dragging command to the icon is received, the position where the icon is dragged is detected; thumbnail previews of all split screens in the desktop are displayed in the set region when the icon is detected to be dragged to the set region in the desktop; the icon can be drag to any one thumbnail preview subsequently; the dragging stopping command to the icon is received, and if the icon is currently dragged to some target thumbnail preview, the icon is moved to the split screen corresponding to the target thumbnail preview. It can be seen that according to the embodiment of the present disclosure, when the icon is moved across the screens, the icon can be directly moved to any split screen corresponding to the thumbnail preview based on the thumbnail previews of all displayed split screens without the need of switching the split screens by adopting a method in the prior art, so that the cross-screen movement is more accurate, the operating process is simpler and more convenient and the moving efficiency is high according to the embodiments of the present disclosure.

### Fourth Embodiment

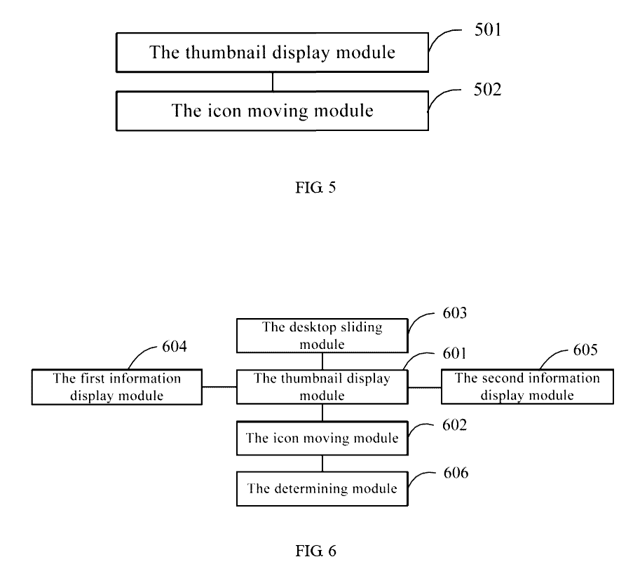

With reference to FIG. 6, a structural block diagram of an icon moving device according to a fourth embodiment of the present disclosure is depicted.

The icon moving device according to the embodiment of the present disclosure can include the following modules:

a thumbnail displaying module 601 for receiving a dragging command to an icon and displaying thumbnail previews of all split screens in the desktop in a set region when the icon is detected to be dragged to the set region in the desktop; and

an icon moving module 602 for receiving the dragging stopping command to the icon, icon moving the icon to the split screen corresponding; to the target thumbnail preview if the icon is currently dragged to some target thumbnail preview.

Preferably, the icon moving device further can include a desktop sliding module 603 for sliding the desktop to the split screen corresponding to the target thumbnail preview when the target icon is dragged to some target thumbnail preview after the thumbnail preview display module displays the thumbnail previews of all split screens in the desktop in the set region,.

Preferably, the icon moving device further can include a first information display module 604 for displaying the prompt information in the set region after the thumbnail preview display module receives the dragging command of an icon. wherein the prompt information is used for prompting that the set region is the cross screen operating region.

Preferably, the icon moving device further can include a second information display module 60 for displaying the prompt information in the set region when the icon is detected to be dragged outside the set region after the thumbnail preview display module displays the thumbnail previews of all split screens in the desktop in the set region.

Preferably, the icon moving device further can include a determining module 606 for determining whether a position for placing the icon is available in the split screen corresponding to the target thumbnail preview or not before the icon moving module moves the icon to the split screen corresponding to the target thumbnail preview; if so, invoking the icon moving module to move the icon to the split screen corresponding to the target thumbnail preview.

In the embodiment of the present disclosure, the thumbnail previews of all split screens can be displayed in the set region, so that the icon can be directly moved to the split screen corresponding to any one thumbnail preview, and therefore, the user can move conveniently perform the operation of moving the icon across the screens, accidental operation during cross-screen movement can be reduced, and the efficiency of cross-screen movement can be improved.

As far as the embodiments of the device are concerned, substantially similar to the embodiments of the method, description is relatively simple, and relevance refers to the description of the embodiments of the method.

The depicted embodiments of the device are only schematic. The units depicted as separated parts can be or cannot be physically separated. The parts displayed as units can be or cannot be physical units, that is, the parts can be located in a same place, or further can be distributed to a plurality of network units. Part of or all of the modules can be selected according to actual needs to realize the purpose of the embodiments of the present disclosure. The ordinary technical staff in the field can understand and implement the embodiments of the present disclosure on the premise of not contributing creative labor.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the interne websites, or be provided in carrier, or be provided in other manners.

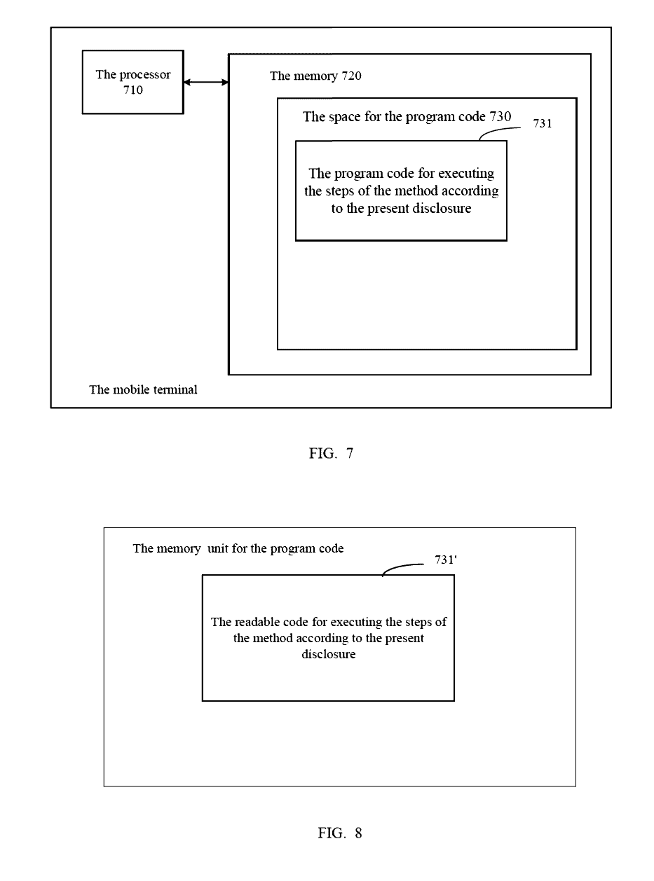

For example, FIG. 7 illustrates a. block diagram of a mobile terminal for executing the method according the disclosure. Traditionally, the mobile terminal includes a processor 710 and a computer program product or a. computer readable medium in form of a memory 720. The memory 720 could be electronic memories such as flash memory, EEPROM (Electrically Erasable Programmable Read-Only Memory), EPROM, bard disk or ROM. The memory 720 has a memory space 730 for executing program codes 731 of any steps in the above methods. For example, the memory space 730 for program codes may include respective program codes 731 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 8. The memory cells may be provided with memory sections, memory spaces, etc., similar to the memory 720 of the server as shown in FIG. 7. The program codes may be compressed for example in an appropriate form. Usually, the memory cell includes computer readable codes 731′ which can be read for example by processors 710. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the embodiments are only used for illustrating the technical scheme of the present disclosure rather than limiting the technical scheme. In spite of illustrating the present disclosure in detail with reference to the embodiments, the ordinary technical staff in the field should understand that the ordinary technical staff in the field still can modify the technical scheme recorded in the embodiments or perform equivalent replacement on part of technical characteristics therein, It will be appreciated that those modifications or variations of the present disclosure do not make the essence of the corresponding technical scheme depart from the spirit or scope of the present disclosure.

What is claimed is:

1. An icon moving method, comprising:
receiving a dragging command to an icon and displaying :a thumbnail preview of a part of split screens in a desktop in a set region when the icon is detected to be dragged to the set region in to desktop; and
receiving a dragging stopping command to the icon, and moving the icon to the split screen corresponding to the target thumbnail preview when the icon is currently dragged to a certain target thumbnail preview.

2. The method according to claim 1, wherein after the step of displaying the thumbnail previews of all split screens in the desktop in the set region, the method further comprises:
sliding the icon to the split screen corresponding to the target thumbnail preview when the icon is detected to be dragged to a certain target thumbnail preview.

3. The method according to claim 1, wherein after the step of receiving the dragging command of an icon, the method further comprises:
displaying the prompt information in the set region, wherein the prompt information is used for prompting that the set region is a cross screen operating region.

4. The method according to claim 1, wherein after the step of displaying the thumbnail previews of all split screens in the desktop in the set region, the method further comprises:
displaying the prompt information in the set region when the icon is detected to be dragged outside the set region, wherein the prompt information is used for prompting that the set region is a cross screen operating region.

5. The method according to claim 1, wherein after the step of moving the icon to the split screen corresponding to the target thumbnail preview, the method further comprises:
determining whether a position for placing the icon is available in the split screen corresponding to the target thumbnail preview or not;
if yes, executing a step of moving the icon to the split screen corresponding to the target thumbnail preview.

6. A mobile terminal for icon moving, comprising:
at least one processor; and
a memory communicably connected with the at least one processor for storing instructions executable by the at least one processor, wherein execution of the instructions by the at least one processor causes the at least one processor to:
receive a dragging command to an icon and display a thumbnail preview of a part of split screens in the desktop in a set region when the icon is detected to be dragged to the set region in the desktop; and
receive a dragging stopping command to the icon, and move the icon to the split screen corresponding to the target thumbnail preview when the icon is currently dragged to a certain target thumbnail preview.

7. The mobile terminal according to claim 6, wherein execution of the instructions by the at least one processor causes the at least one processor to:
slide the desktop to the split screen corresponding to the target thumbnail preview when the icon is detected to be dragged to a certain target thumbnail preview.

8. The mobile terminal according to claim 6, wherein execution of the instructions by the at least one processor causes the at least one processor to:
display the prompt information in the set region, wherein the prompt information is used for prompting that the set region is the cross screen operating region.

9. The mobile terminal according to claim 6, wherein execution of the instructions by the at least one processor causes the at least one processor to:
display the prompt information in the set region when the icon is detected to be dragged outside the set region, wherein the prompt information is used for prompting that the set region is a cross screen operating region.

10. The mobile terminal according to claim 6, wherein execution of the instructions by the at least one processor causes the at least one processor to:
determine whether a position for placing the icon is available in the split screen corresponding to the target thumbnail preview or not; if yes, move the icon to the split screen corresponding to the target thumbnail preview.

11. A non-transitory computer readable medium storing executable instructions that, when executed by a mobile terminal, cause the electronic device to:
receive a dragging command to an icon and display a thumbnail preview of a part of split screens in a desktop in a set region when the icon is detected to be dragged to the set region in the desktop;
and receive a dragging stopping command to the icon, and move the icon to the split screen corresponding to the target thumbnail preview when the icon is currently dragged to a certain target thumbnail preview.
